(19) United States
(12) Patent Application Publication
(10) Pub. No.: US 2016/0130863 A1
(43) Pub. Date: May 12, 2016

(54) Light Input-adjustable Window Shade

(71) Applicant: Li-Ming Cheng, Kaohsiung City (TW)

(72) Inventor: Li-Ming Cheng, Kaohsiung City (TW)

(21) Appl. No.: 14/536,760

(22) Filed: Nov. 10, 2014

(51) Int. Cl. E06B 9/24

(52) U.S. Cl. CPC E06B 9/24

(57) ABSTRACT

A light input-adjustable window shade includes a supporting member having first and second ends respectively coupled to a positioning seat and a level fixing device. The level fixing device includes a housing and a transmission unit mounted in the housing. The transmission unit includes a rotational shaft extending beyond the housing. A first end of a spool is rotatably mounted to the positioning seat. A second end of the spool is coupled to the rotational shaft of the level fixing device. A first periphery of a shade body is fixed to and coiled around the spool. The shade body is wound around a rod of a weighting unit. A second periphery of the shade body is fixed to a coupling portion of the supporting member.

### BACKGROUND OF THE INVENTION

1. Field of the Invention

The present invention relates to a light input-adjustable window shade and, more particularly, to a light input-adjustable window shade including a level fixing device.

2. Description of the Related Art

FIG. 1 shows a conventional light input-adjustable window shade 9 including a supporting rod 91, a spool 92, a blind sheet or a shade body 93, and a weighting rod 94. The supporting rod 91 is mounted to a top of a door or a window. A spool 92 is mounted to the supporting rod 91. An end of the shade body 93 is fixed to and coiled around the spool 92. The other end of the shade body 93 is wound around the weighting rod 94 and is coupled to the supporting rod 91. Thus, the shade body 93 is folded relative to the weighting rod 94 to form a dual-layer shade body structure permitting adjustment of the light input amount. An example of such a light input-adjustable window shade is disclosed in U.S. Pat. No. 7,267,156.

In use of the conventional light input-adjustable window shade 9, if a user is intended to uncoil the shade body 93, the user can directly pull the weighting rod 94 downwards to move the shade body 93 downwards, which, in turn, causes rotation of the spool 92 to unfold the shade body 93. On the other hand, when the user is intended to coil the shade body 93, the spool 93 cannot be rotated to coil the shade body 93 by pushing the weighting rod 94, because the shade body 93 is made of a flexible material. Namely, the user cannot coil the shade body 93 by directly pushing the weighting rod 94.

Thus, the conventional light input-adjustable window shade 9 must include an actuation member 95 in the form of a bead chain or a pull cord, and the actuation member 95 is coupled to the spool 92. If the user is intended to coil the shade body 93, the user can operate the actuation member 95 to rotate the spool 92 to thereby coil the shade body 93 around the spool 92. However, the user has to operate the actuation member 95 to move the shade body 93 upwards for coiling purposes, which is inconvenient to use. Furthermore, the actuation member 95 is liable to damage (such as rusting of the bead chain or breakage of the pull cord) due to oxidation or brittlement, shortening the service life of the conventional light input-adjustable window shade 9 and increasing the maintenance costs.

In view of the disadvantages of inconvenient use, short service life, and high maintenance costs of the Conventional light input-adjustable window shade 9 using an actuating member 95, a need exists for a novel light input-adjustable window shade without the actuation member 95 to permit easy coiling and uncoiling of the shade body 93 to thereby increase the market value of the light input-adjustable window shades.

### SUMMARY OF THE INVENTION

An objective of the present invention is to provide a light input-adjustable window shade including a level fixing device permitting a user to pull or push a weighting member to coil or uncoil a shade body, increasing use convenience of the light input-adjustable window shade.

The present invention fulfills the above objective by providing a light input-adjustable window shade including a supporting member having first and second ends respectively coupled to a positioning seat and a level fixing device. The supporting member further includes a coupling portion. The level fixing device includes a housing and a transmission unit mounted in the housing. The transmission unit includes a rotational shaft extending beyond the housing. A first end of a spool is rotatably mounted to the positioning seat. A second end of the spool is coupled to the rotational shaft of the level fixing device. A first periphery of a shade body is fixed to and coiled around the spool. A weighting unit includes a rod. The shade body is wound around the rod. A second periphery of the shade body is fixed to the coupling portion of the supporting member.

In a first embodiment, the transmission unit includes a first transmission wheel, a second transmission wheel, and an elastic element. The first and second transmission wheels are rotatably positioned in the housing. The first transmission wheel includes the rotational shaft. The elastic element includes two ends respectively mounted to the first and second transmission wheels.

In the first embodiment, the housing can include first and second housing parts coupled to each other. The housing includes a through-hole and a first positioning peg. The through-hole extends through two sides of the first housing part. The first positioning peg is provided on the second housing part. The first transmission wheel includes a first side facing the first housing part and a second side facing the second housing part. The rotational shaft is formed on the first side of the first transmission wheel. The rotational shaft is aligned with the through-hole. The rotational shaft extends beyond the housing via the through-hole. The second side of the first transmission wheel includes a first positioning hole aligned with the first positioning peg. The first positioning peg extends into the first positioning hole to position the first transmission wheel.

In the first embodiment, the elastic element can be an S-shaped spring, a helical spring, or a coil spring.

In the first embodiment, the housing can further include a second positioning peg. The second transmission wheel can include a second positioning hole aligned with the second positioning peg. The second positioning peg extends into the second positioning hole to position the second transmission wheel.

In the first embodiment, the second positioning peg of the housing can be hollow, and the second positioning hole can be a through-hole extending through two sides of the second transmission wheel. The housing can further include a fixing hole. One of the fixing hole and the second positioning peg is formed on one of the first and second housing parts, and the other of the fixing hole and the second positioning peg is formed on the other of the first and second housing parts. A fastener extends through the fixing hole and the second positioning hole and is fixed to the second positioning peg.

In the first embodiment, the first transmission wheel can include a first gear portion on an outer edge thereof, and the second transmission wheel can include a second gear portion on an outer edge thereof. The second gear portion meshes with the first gear portion.

In a second embodiment, the transmission unit includes a first transmission wheel, a second transmission wheel, an elastic element, and a third transmission wheel. The first and second transmission wheels are rotatably positioned in the housing. The first transmission wheel includes a first gear portion on an outer edge thereof. The third transmission wheel includes the rotational shaft and a third gear portion on an outer edge thereof. The elastic element includes two ends respectively mounted to the first and second transmission wheels. The third gear portion meshes with the first gear portion.

In the second embodiment, the housing can include first and second housing parts coupled to each other. The housing can include a through-hole and a first positioning peg. The through-hole extends through two sides of the first housing part. The first positioning peg is provided on the second housing part. The third transmission wheel includes a first side facing the first housing part and a second side facing the second housing part. The rotational shaft is formed on the first side of the third transmission wheel. The rotational shaft is aligned with the through-hole. The rotational shaft extends beyond the housing via the through-hole. The second side of the first transmission wheel includes a third positioning hole aligned with the first positioning peg. The first positioning peg extends into the third positioning hole to position the first transmission wheel.

In the second embodiment, the elastic element can be an S-shaped spring, a helical spring, or a coil spring.

In the second embodiment, the housing can further include a second positioning peg and a third positioning peg. The second transmission wheel can include a second positioning hole aligned with the second positioning peg. The second positioning peg extends into the second positioning hole to position the second transmission wheel. The first positioning hole is aligned with the third positioning peg. The third positioning peg extends into the first positioning hole to position the first transmission wheel.

In the second embodiment, the second positioning peg of the housing can be hollow, and the second positioning hole can be a through-hole extending through two sides of the second transmission wheel. The housing can further include a first fixing hole. One of the first fixing hole and the second positioning peg is formed on one of the first and second housing parts. The other of the first fixing hole and the second positioning peg is formed on the other of the first and second housing parts. A first fastener extends through the first fixing hole and the second positioning hole and is fixed to the second positioning peg. The third positioning peg of the housing can be hollow, and the first positioning hole can be a through-hole extending through two sides of the first transmission wheel. The housing can further include a second fixing hole. One of the second fixing hole and the third positioning peg is formed on one of the first and second housing parts. The other of the second fixing hole and the third positioning peg is formed on the other of the first and second housing parts. A second fastener extends through the second fixing hole and the first positioning hole and is fixed to the third positioning peg.

In another embodiment, the second transmission wheel can include a second gear portion on an outer edge thereof. The second gear portion meshes with the first gear portion.

The positioning seat can include a positioning portion and a pivotal portion. The positioning portion is coupled to the first end of the supporting member. The first end of the spool is coupled to the pivotal portion.

The pivotal portion of the positioning seat can be a pivot, and the first end of the spool can include a receptacle. The receptacle rotatably receives the pivotal portion of the positioning seat.

In an embodiment, the housing includes first and second housing parts coupled to each other, and the first housing part includes a positioning member coupled to the second end of the supporting member.

The rotational shaft can have non-circular cross sections, and the second end of the spool can include a hole with non-circular cross sections. The rotational shaft is fixed in the hole of the spool.

The shade body can include a plurality of light-impermeable portions and a plurality of light-permeable portions. Each of the plurality of light-impermeable portions is located between two adjacent light-permeable portions.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 is a perspective view of a conventional light input-adjustable window shade.

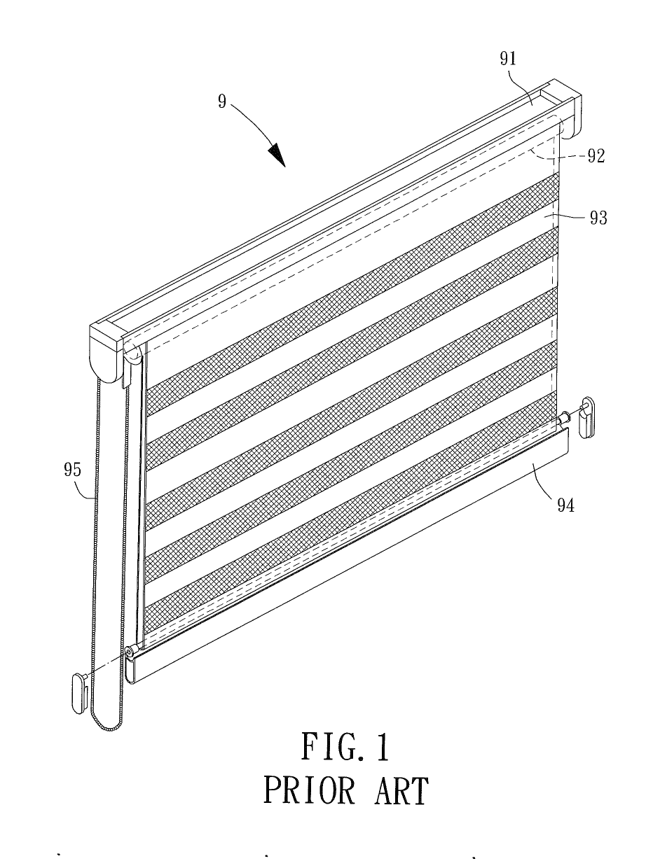

FIG. 2 is an exploded, perspective view of a light input-adjustable window shade of a first embodiment according to the present invention:

FIG. 3 is an exploded, perspective view of a level fixing device of the light input-adjustable window shade of FIG. 2.

FIG. 4 is a cross sectional view of the level fixing device of FIG. 3.

FIG. 5 is an exploded, perspective view of a level fixing device of a light input-adjustable window shade of a second embodiment according to the present invention.

FIG. 6 is a cross sectional view of the level fixing device of FIG. 5.

FIG. 7 is an exploded, perspective view of a level fixing device of a light input-adjustable window shade of a third embodiment according to the present invention.

FIG. 8 is a cross sectional view of the level fixing device of FIG. 7.

### DETAILED DESCRIPTION OF THE INVENTION

The term “light input-adjustable window shade” referred to hereinafter means a dual-layer window shade, such as a rainbow curtain or an accordion curtain, which can be coiled to provide a light shielding effect while the dual-layer window shade permits adjustment of the light input amount, which can be appreciated by one having ordinary skill in the art.

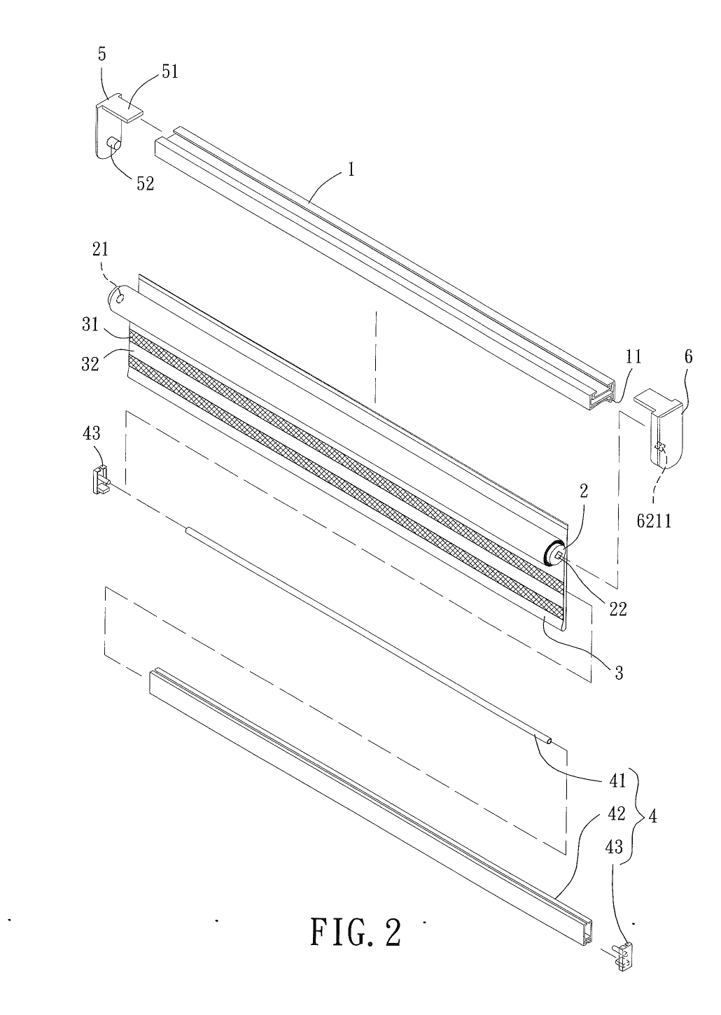

With reference to FIG. 2, a light input-adjustable window shade of a first embodiment according to the present invention includes a supporting member 1, a spool 2, a shade body 3, and a weighting unit 4. The supporting member 1 includes first and second ends respectively coupled to a positioning seat 5 and a level fixing device 6. The spool 2 includes first and second ends 21 and 22. The first end 21 of the spool 2 is rotatably mounted to the positioning seat 5. The second end 22 of the spool 2 is coupled to the level fixing device 6. The supporting member 1 further includes a coupling portion 11. The weighting unit 4 includes a rod 41. A first periphery of the shade body 3 is fixed to and coiled around the spool 2. The shade body 3 is wound around the rod 41. A second periphery of the shade body 3 is fixed to the coupling portion 11 of the supporting member 1.

The shade body 3 can include a plurality of light-impermeable portions 31 and a plurality of light-permeable portions 32. Each light-impermeable portion 31 is located between two adjacent light-permeable portions 32. When a user moves the shade body 3 upwards or downwards, a change in the areas of the light-impermeable portions 31 and the light-permeable portions 32 can be used to adjust the light input amount. Thus, the light input-adjustable window shade according to the present invention forms a rainbow curtain. Furthermore, in addition to the rod 41, the weighting unit 4 can include a weighting beam 42 and two end caps 43. The rod 41 is mounted in the weighting beam 42. The rod 41 and the weighting beam 42 are coupled between the end caps 43.

The positioning seat 5 includes a positioning portion 51 and a pivotal portion 52. The positioning portion 51 can be any fixing structure (such as a mortise, a tenon, or a hook) and is coupled to the first end of supporting member 1. The pivotal portion 52 can be a rotational mechanism, such as a pivot or a bearing. The first end 21 of the spool 2 is rotatably coupled to the pivotal portion 52 such that the spool 2 is rotatably coupled to the positioning seat 5. In this embodiment, the pivotal portion 52 is a pivot, and the first end 21 of the spool 2 includes a receptacle rotatably receiving the pivotal portion 52.

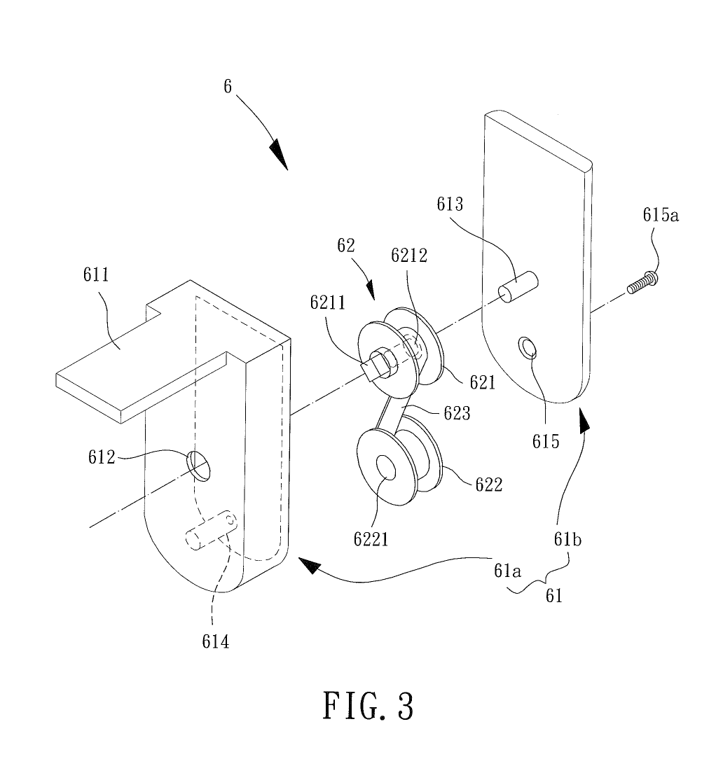

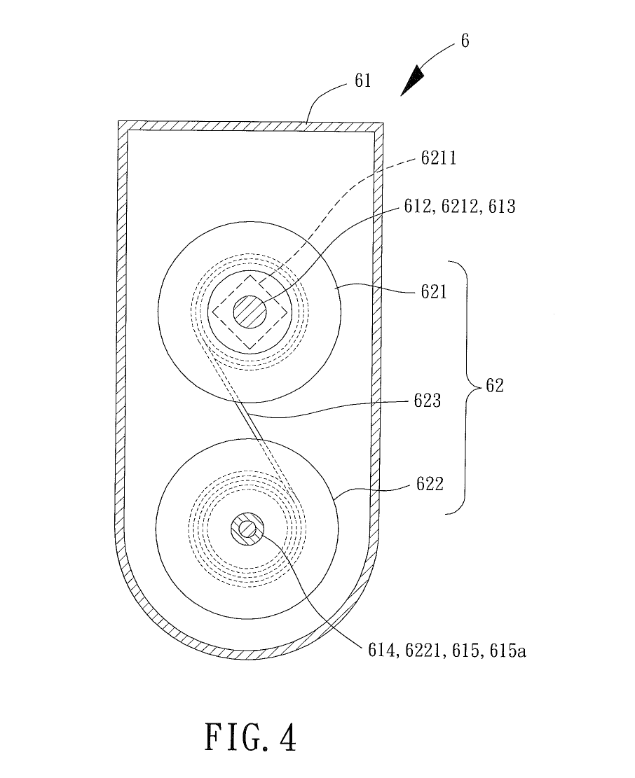

With reference to FIGS. 3 and 4, in this embodiment, the level fixing device 6 includes a housing 61 and a transmission unit 62 mounted in the housing 61. The housing 61 includes first and second housing parts 61a and 61b coupled to each other. The transmission unit 62 is covered by and positioned between the first and second housing parts 61a and 61b. The first housing part 61a is at a side of the level fixing device 6 adjacent to the supporting member 1. The second housing part 61b is at the other side of the level fixing device 6 distant to the supporting member 1. The housing 61 includes a positioning member 611, a through-hole 612, a first positioning peg 613, and a second positioning peg 614. The positioning member 611 can be any fixing structure (such as a mortise, a tenon, or a hook). The positioning member 611 can be formed on the first housing part 61a and is coupled to the second end of the supporting member 1. The through-hole 612 extends through two sides of the first housing part 61a. Namely, the through-hole 612 extends from a side of the first housing part 61 a facing the supporting member 1 through the other side of the first housing part 61a facing the second housing part 61b.

The transmission unit 62 includes a first transmission wheel 621, a second transmission wheel 622, and an elastic element 623. The first and second transmission wheels 621 and 622 are rotatably positioned in the housing 61. The first transmission wheel 621 includes a first side facing the first housing part 61a and a second side facing the second housing part 61b. A rotational shaft 6211 is formed on the first side of the first transmission wheel 621 facing the first housing part 61a. The second side of the first transmission wheel 621 facing the second housing part 61b includes a first positioning hole 6212. The rotational shaft 6211 and the first positioning hole 6212 are coaxial to an axis of the first transmission wheel 621. The rotational shaft 6211 is aligned with the through-hole 612 of the housing 61. The rotational shaft 6211 extends beyond the housing 61 via the through-hole 612 to couple with the second end 22 of the spool 2 distant to the positioning seat 5. The rotational shaft 6211 can have non-circular cross sections, and the second end 22 of the spool 2 can include a hole with non-circular cross sections. Thus, the rotational shaft 6211 can be fixed in the hole of the spool 2. As a result, the rotational shaft 6211 is driven to rotate when the spool 2 rotates. Likewise, the spool 2 is driven to rotate when the rotational shaft 6211 rotates. The first positioning peg 613 of the housing 61 can be provided on the second housing part 61b. The first positioning hole 6212 is aligned with the first positioning peg 613. The first positioning peg 613 extends into the first positioning hole 6212 to position the first transmission wheel 621.

The second transmission wheel 622 includes a second positioning hole 6221 coaxial to an axis of the second transmission wheel 622. The second positioning peg 614 of the housing 61 can be provided on the first housing part 61a or the second housing part 61b. The second positioning hole 6221 is aligned with the second positioning peg 614. The second positioning peg 614 extends into the second positioning hole 6221 to position the second transmission wheel 622. By such an arrangement, the first transmission wheel 621 can rotate relative to the first positioning peg 613, and the second transmission wheel 622 can rotate relative to the second positioning peg 614, such that the first and second transmission wheels 621 and 622 are rotatably positioned in the housing 61.

The elastic element 623 can be an S-shaped spring, a helical spring, or a coil spring. The elastic element 623 includes two ends respectively mounted to the first and second transmission wheels 621 and 622. Furthermore, the second positioning peg 614 of the housing 61 is hollow, and the second positioning hole 6221 is a through-hole extending through two sides of the second transmission wheel 622. The housing 61 further includes a fixing hole 615. One of the fixing hole 615 and the second positioning peg 614 is formed on one of the first and second housing parts 61a and 61b, and the other of the fixing hole 615 and the second positioning peg 614 is formed on the other of the first and second housing parts 61a and 61b. In an example shown in FIG. 3, the second positioning peg 614 is formed on the first housing part 61a, and the fixing hole 615 is formed in second housing part 61b. Furthermore, the second positioning peg 614 and the fixing hole 615 are aligned with each other in an extending direction of the second positioning hole 6221. A fastener 615a (such as a screw) extends through the fixing hole 615 and the second positioning hole 6221 and is fixed to the second positioning peg 614 to couple the first and second housing parts 61a and 61b together.

If a user is intended to coil or uncoil the shade body 3, the weighting unit 4 can be used as a balancing rod to be pushed or pulled by the user, and the transmission unit 62 of the level fixing device 6 can be actuated to move the shade body 3 upwards for coiling purposes or downwards for uncoiling purposes. Specifically, after the shade body 3 has been moved to a desired level, the weight of the weighting unit 4 creates a downward pulling force which exerts on the spool 2 to create a first torque. The returning force of the elastic element 623 of the transmission unit 62 permits a portion of the elastic element 623 wound around the first transmission wheel 621 to be pulled towards the second transmission wheel 622 to create a second torque on the first transmission wheel 621. The first torque and the second torque are opposite in directions. The first torque can be equal to the second torque in magnitude. Since the first transmission wheel 621 is connected to the spool 2 via the rotational shaft 6211, the first torque counterbalances the second torque such that the shade body 3 can be retained in the desired level. Thus, the shade body 3 can be retained in the desired level without further moving upwards or downwards after the user has pulled the weighting unit 4 downwards or pushed the weighting unit 4 upwards.

By the above arrangement, in use of the light input-adjustable window shade of the first embodiment according to the present invention, the user can pull the weighting unit 4 downwards to move the shade body 3 downwards or can push the weighting unit 4 upwards to counterbalance the pulling force resulting from the weight of the weighting unit 4 such that the weight of the weighting unit 4 no longer creates the first torque on the spool 2. In this case, the returning force of the elastic element 623 of the transmission unit 62 still creates the second torque on the first transmission wheel 621, and the second torque urges the first transmission wheel 621 to drive the spool 2 to rotate, thereby coiling the shade body 3. In comparison with the conventional light input-adjustable window shade 9 using an actuation member 95 in the form of a bead chain or a pull cord to drive the spool 2 to rotate for coiling the shade body 93 around the spool 2, the light input-adjustable window shade of the first embodiment according to the present invention, due to provision of the level fixing device 6, permits the uncoiling or coiling of the shade body 3 by simply pulling the weighting unit 4 downwards or by moving the weighting unit 4 upwards, increasing use convenience of the light input-adjustable window shade.

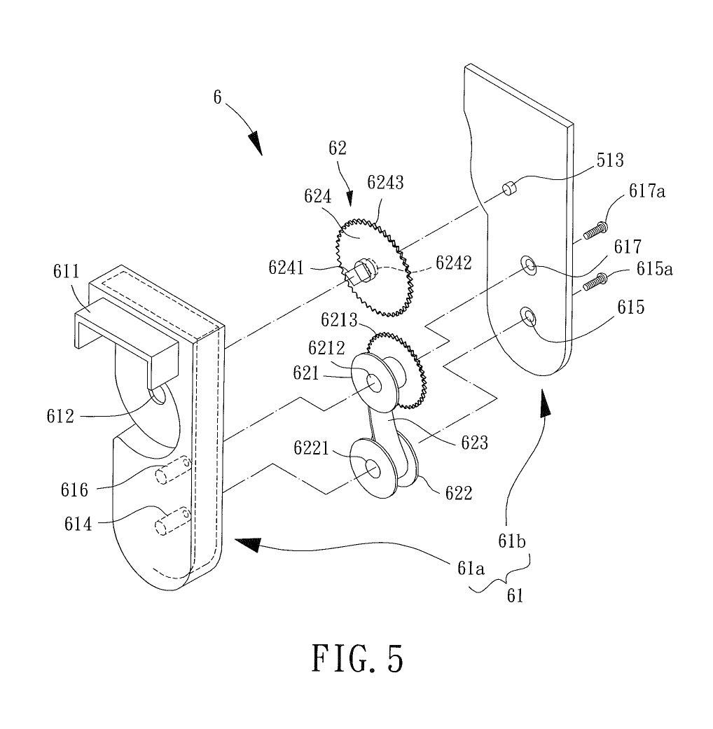

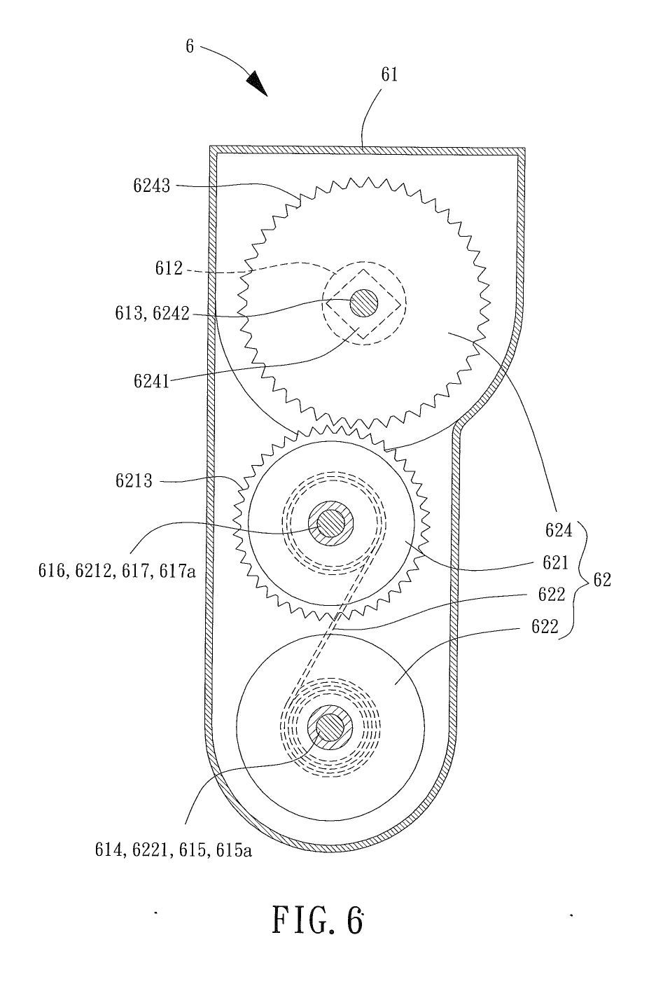

FIGS. 5 and 6 show a level fixing device 6 of a second embodiment of the light input-adjustable window shade according to the present invention. The level fixing device 6 also includes a housing 61 and a transmission unit 62. The differences between the second embodiment and the first embodiment are that the transmission unit 62 further includes a third transmission wheel 624 in addition to the first transmission wheel 621, the second transmission wheel 622, and the elastic element 623. Furthermore, the housing 61 further includes a third positioning peg 616. Specifically, in this embodiment, the first, second, and third transmission wheels 621, 622, and 624 are rotatably positioned in the housing 61. The first transmission wheel 621 includes a first positioning hole 6212 and a first gear portion 6213. The first positioning hole 6212 is coaxial to an axis of the first transmission wheel 621. The first gear portion 6213 is formed on an outer edge of the first transmission wheel 621. The third positioning peg 616 of the housing 61 can be formed on the first housing part 61a or the second housing part 61b. Furthermore, the first positioning hole 6212 is aligned with the third positioning peg 616. The third positioning peg 66 extends into the first positioning hole 6212 to position the second transmission wheel 621.

The third transmission wheel 624 includes a first side facing the first housing part 61a and a second side facing the second housing part 61b. A rotational shaft 6241 is formed on the first side of the third transmission wheel 624 facing the first housing part 61a. A third positioning hole 6242 is formed in the second side of the third transmission wheel 624 facing the second housing part 61b. The rotational shaft 6241 and the third positioning hole 6242 are coaxial to an axis of the third transmission wheel 624. The third transmission wheel 624 further includes a third gear portion 6243 on an outer edge thereof. The rotational shaft 6241 is aligned with the through-hole 612. The rotational shaft 6241 extends beyond the housing 61 via the through-hole 612 to couple with the second end 22 of the spool 2 distant to the positioning seat 5. Thus, the first transmission wheel 621 can rotate relative to the third positioning peg 616, the second transmission wheel 622 can rotate relative to the second positioning peg 614, and the third transmission wheel 624 can rotate relative to the first positioning peg 613. Furthermore, the third gear portion 6243 meshes with the first gear portion 6213 such that the first transmission wheel 621 and the third transmission wheel 624 can driven each other to rotate.

In this embodiment, the elastic element 623 includes two ends respectively mounted to the first and second transmission wheels 621 and 622. Furthermore, the third positioning peg 616 of the housing 61 is hollow, and the first positioning hole 6212 is a through-hole extending through two sides of the first transmission wheel 621. The housing 61 further includes another fixing hole 617. One of the fixing hole 617 and the third positioning peg 616 is formed on one of the first and second housing parts 61a and 61b. The other of the fixing hole 617 and the third positioning peg 616 is formed on the other of the first and second housing parts 61a and 61b. The third positioning peg 616 and the fixing hole 617 are aligned with each other in an extending direction of the first positioning hole 6212. Another fastener 617a extends through the fixing hole 617 and the first positioning hole 6212 and is fixed to the third positioning peg 616 to couple the first and second housing parts 61a and 61b together.

In the light input-adjustable window shade of the second embodiment according to the present invention, since the transmission unit 62 of the level fixing device 6 further includes the third transmission wheel 624, the magnitude of the first torque can be more easily designed to be equal to that of the second torque by adjusting the gear ratio between the third gear portion 6243 of the third transmission wheel 624 and the first gear portion 6213 of the first transmission wheel 621.

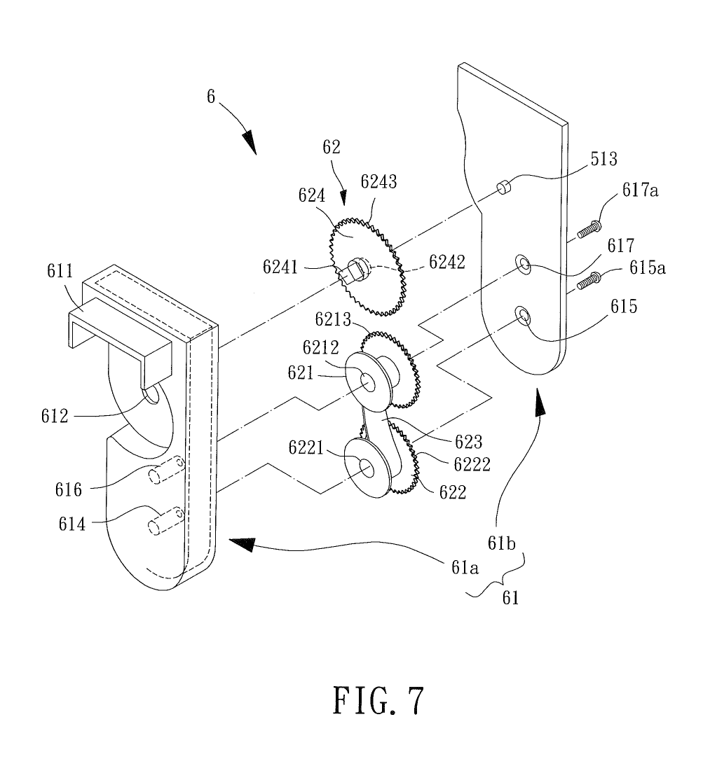

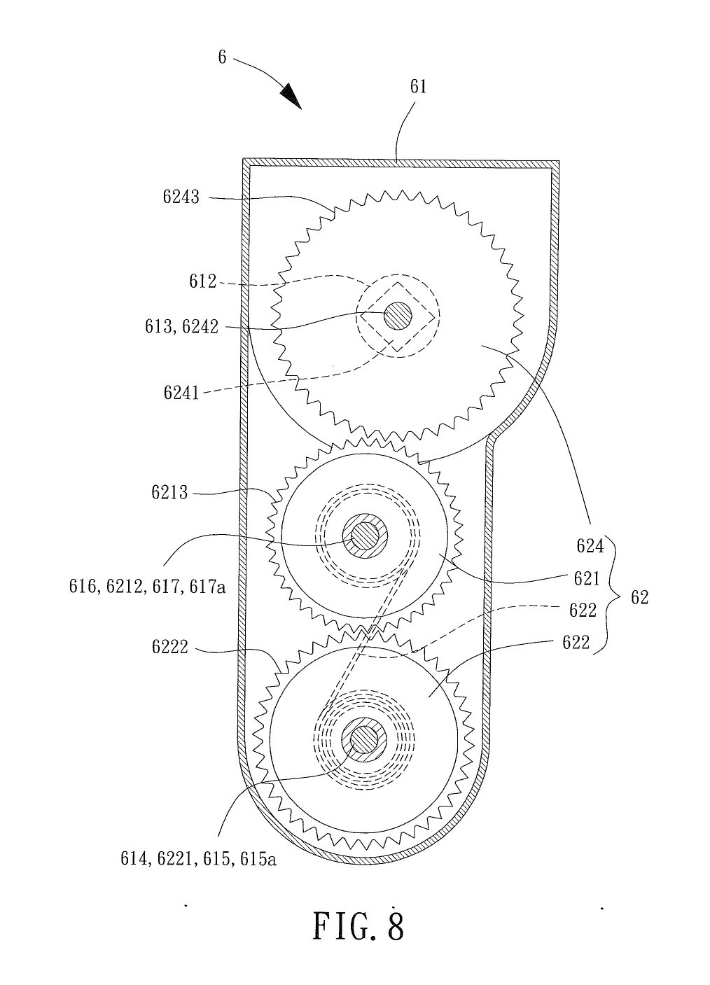

FIGS. 7 and 8 show a third embodiment of the light input-adjustable window shade according to the present invention modified from the second embodiment. In this embodiment, the first transmission wheel 621 includes a first gear portion 6213 on an outer edge thereof, and the second transmission wheel 622 includes a second gear portion 6222 on an outer edge thereof. The second gear portion 6222 meshes with the first gear portion 6213 such that the first transmission wheel 621 and the second transmission wheel 622 can drive each other to rotate. In comparison with the first embodiment in which the transmission unit 62 of the level fixing device 6 only relies on the elastic element 623 to create joint movement of the first transmission wheel 621 and the second transmission wheel 622, the first and second gear portions 6213 and 6222 on the first and second transmission wheels 621 and 622 provide a more reliable joint movement relation for the first and second transmission wheels 621 and 622. Thus, extension or retraction of the elastic element 623 between the first and second transmission wheels 621 and 622 is smoother.

In view of the foregoing, the level fixing device 6 of the light input-adjustable window shade in each embodiment according to the present invention permits the user to simply pull or push the weighting unit 4 to coil or uncoil the shade body 3 without using the actuation member 95 required in the conventional light input-adjustable window shade 9. Namely, the user does not have to operate the actuating member 95 to move the shade body 93 for coiling purposes. Instead, the user can directly control the shade body 3 by the weighting unit 4, such that the shade body 3 can directly be moved upwards for coiling purposes or moved downwards for uncoiling purposes, increasing the use convenience of the light input-adjustable window shade.

Furthermore, the light input-adjustable window shade in each embodiment according to the present invention does not have to include the actuation member 95 that is liable to damage due to oxidation or brittlement resulting from a long period of time of use. Thus, the service life of the light input-adjustable window shade can be prolonged, and the maintenance costs of the light input-adjustable window shade can be reduced.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A light input-adjustable window shade comprising:
a supporting member including first and second ends respectively coupled to a positioning seat and a level fixing device, with the supporting member further including a coupling portion, with the level fixing device including a housing and a transmission unit mounted in the housing, with the transmission unit including a rotational shaft extending beyond the housing;
a spool including first and second ends, with the first end of the spool rotatably mounted to the positioning seat, with the second end of the spool coupled to the rotational shaft of the level fixing device;
a shade body including first and second peripheries, with the first periphery of the shade body fixed to and coiled around the spool; and
a weighting unit including a rod, with the shade body wound around the rod, and with the second periphery of the shade body fixed to the coupling portion of the supporting member.

2. The light input-adjustable window shade as claimed in claim 1, with the transmission unit including a first transmission wheel, a second transmission wheel, and an elastic element, with the first and second transmission wheels rotatably positioned in the housing, with the first transmission wheel including the rotational shaft, and with the elastic element including two ends respectively mounted to the first and second transmission wheels.

3. The light input-adjustable window shade as claimed in claim 2, with the housing including first and second housing parts coupled to each other, with the housing including a through-hole and a first positioning peg, with the through-hole extending through two sides of the first housing part, with the first positioning peg provided on the second housing part, with the first transmission wheel including a first side facing the first housing part and a second side facing the second housing part, with the rotational shaft formed on the first side of the first transmission wheel, with the rotational shaft aligned with the through-hole, with the rotational shaft extending beyond the housing via the through-hole, with the second side of the first transmission wheel including a first positioning hole aligned with the first positioning peg, and with the first positioning peg extending into the first positioning hole to position the first transmission wheel.

4. The light input-adjustable window shade as claimed in claim 3, wherein the elastic element is an S-shaped spring, a helical spring, or a coil spring.

5. The light input-adjustable window shade as claimed in claim 3, with the housing further including a second positioning peg, with the second transmission wheel including a second positioning hole aligned with the second positioning peg, and with the second positioning peg extending into the second positioning hole to position the second transmission wheel.

6. The light input-adjustable window shade as claimed in claim 5, with the second positioning peg of the housing being hollow, with the second positioning hole being a through-hole extending through two sides of the second transmission wheel, with the housing further including a fixing hole, with one of the fixing hole and the second positioning peg formed on one of the first and second housing parts, with another of the fixing hole and the second positioning peg formed on another of the first and second housing parts, and with a fastener extending through the fixing hole and the second positioning hole and fixed to the second positioning peg.

7. The light input-adjustable window shade as claimed in claim 3, with the first transmission wheel including a first gear portion on an outer edge thereof, with the second transmission wheel including a second gear portion on an outer edge thereof, and with the second gear portion meshed with the first gear portion.

8. The light input-adjustable window shade as claimed in claim 1, with the transmission unit including a first transmission wheel, a second transmission wheel, an elastic element, and a third transmission wheel, with the first and second transmission wheels rotatably positioned in the housing, with the first transmission wheel including a first gear portion on an outer edge thereof, with the third transmission wheel including the rotational shaft and a third gear portion on an outer edge thereof, with the elastic element including two ends respectively mounted to the first and second transmission wheels, and with the third gear portion meshed with the first gear portion.

9. The light input-adjustable window shade as claimed in claim 8, with the housing including first and second housing parts coupled to each other, with the housing including a through-hole and a first positioning peg, with the through-hole extending through two sides of the first housing part, with the first positioning peg provided on the second housing part, with the third transmission wheel including a first side facing the first housing part and a second side facing the second housing part, with the rotational shaft formed on the first side of the third transmission wheel, with the rotational shaft aligned with the through-hole, with the rotational shaft extending beyond the housing via the through-hole, with the second side of the first transmission wheel including a third positioning hole aligned with the first positioning peg, and with the first positioning peg extending into the third positioning hole to position the first transmission wheel.

10. The light input-adjustable window shade as claimed in claim 8, wherein the elastic element is an S-shaped spring, a helical spring, or a coil spring.

11. The light input-adjustable window shade as claimed in claim 8, with the housing further including a second positioning peg and a third positioning peg, with the second transmission wheel including a second positioning hole aligned with the second positioning peg, with the second positioning peg extending into the second positioning hole to position the second transmission wheel, with the first positioning hole aligned with the third positioning peg, and with the third positioning peg extending into the first positioning hole to position the first transmission wheel.

12. The light input-adjustable window shade as claimed in claim 11, with the second positioning peg of the housing being hollow, with the second positioning hole being a through-hole extending through two sides of the second transmission wheel, with the housing further including a first fixing hole, with one of the first fixing hole and the second positioning peg formed on one of the first and second housing parts, with another of the first fixing hole and the second positioning peg formed on another of the first and second housing parts, with a first fastener extending through the first fixing hole and the second positioning hole and fixed to the second positioning peg, with the third positioning peg of the housing being hollow, with the first positioning hole being a through-hole extending through two sides of the first transmission wheel, with the housing further including a second fixing hole, with one of the second fixing hole and the third positioning peg formed on one of the first and second housing parts, with another of the second fixing hole and the third positioning peg formed on the other of the first and second housing parts, with a second fastener extending through the second fixing hole and the first positioning hole and fixed to the third positioning peg.

13. The light input-adjustable window shade as claimed in claim 8, with the second transmission wheel including a second gear portion on an outer edge thereof, and with the second gear portion meshed with the first gear portion.

14. The light input-adjustable window shade as claimed in claim 1, with the positioning seat including a positioning portion and a pivotal portion, with the positioning portion coupled to the first end of the supporting member, and with the first end of the spool coupled to the pivotal portion.

15. The light input-adjustable window shade as claimed in claim 14, with the pivotal portion of the positioning seat being a pivot, with the first end of the spool including a receptacle, and with the receptacle rotatably receiving the pivotal portion of the positioning seat.

16. The light input-adjustable window shade as claimed in claim 1, with the housing including first and second housing parts coupled to each other, and with the first housing part including a positioning member coupled to the second end of the supporting member.

17. The light input-adjustable window shade as claimed in claim 1, with the rotational shaft having non-circular cross sections, with the second end of the spool including a hole with non-circular cross sections, and with the rotational shaft fixed in the hole of the spool.

18. The light input-adjustable window shade as claimed in claim 1, with the shade body including a plurality of light-impermeable portions and a plurality of light-permeable portions, and with each of the plurality of light-impermeable portions located between two adjacent light-permeable portions.
